(19) United States
(12) Patent Application Publication
(10) Pub. No.: US 2017/0203138 A1
(43) Pub. Date: Jul. 20, 2017

(54) Apparatus and Method for the Disposal of Waste Pharmaceuticals

(71) Applicant: Vail Scientific, LLC, Inver Grove Heights, MN (US)

(72) Inventors: Carter R. Anderson, Inver Grove Heights, MN (US); Russell L. Morris, Lindstrom, MN (US); Thomas Burke, Plymouth, MN (US); Clayton Anderson, Lakeville, MN (US)

(21) Appl. No.: 15/394,248

(22) Filed: Dec. 29, 2016

Related U.S. Application Data
(60) Provisional application No. 62/388,145, filed on Jan. 20, 2016.

(51) Int. Cl. A62D 3/33; B65D 25/02; B01D 35/04; B65D 25/40; B01D 15/22; B01D 29/92

(52) U.S. Cl. CPC A62D 3/33; B01D 15/22; B01D 29/92; B01D 35/04; B65D 25/40; B65D 25/02

(57) ABSTRACT

Disclosed are embodiments of an apparatus for disposal of liquid medications. The apparatus includes activated carbon to capture the active ingredients in the liquid medication before disposal.

### BACKGROUND

Pharmaceutical contamination of our nation's water supplies has become a well known problem, with numerous reports published. Virtually everyone is aware of the issue to some degree. Consequently, authorities generally now recommend against the sink or toilet disposal of unwanted medications.

Hospitals and clinics routinely encounter the need to dispose of unwanted medications; for example, patients may not be responsive to a given medication and a change to a new medication is made before the first medication is fully used. In other situations, patients may be discharged before medications are fully consumed. In yet other situations, the medication amount dispensed and/or otherwise available may exceed that required for the patient, and there is a need to dispose of the excess amount.

Every nurse will encounter the need to dispose of “waste” meds several times during any given shift. Medications are often in the form of liquid contained in syringes or in partial IV bags. Because many of these medications are narcotics, they are extremely expensive to dispose through waste services, given the DEA requirements related to transfer of ownership and shipping restrictions. Consequently, many hospitals still routinely dispose of these medications in sinks because there is no economically viable alternative. While economical and convenient, this practice results in pharmaceutical contamination of the local watershed.

Alternatively, unwanted medications are disposed through waste pick-up services. Typically, a waste service may routinely collect unwanted waste at the site and transport it to a treatment facility. In many cases, unwanted medications are then incinerated at the treatment facility for destruction purposes. While effective, this process can be very expensive, as it encompasses the cost labor, transport, and destruction of unwanted medications. It would not be unusual for this service to cost $2 per pound of unwanted medication, or more. Consequently, it would cost approximately $300 to collect and dispose 15 gallons of liquid medication waste. Since liquid waste medications are typically comprised of over 95% water, and disposal costs for waste medications are calculated by the total pound (which includes that water), hospitals are paying a significant amount of money for services to collect and dispose of water.

Mail-back containers are also available. With these, liquid or solid medication wastes are placed in the container, and then it is sealed and mailed to a treatment facility. This method is also very expensive, and may cost $450 or more to dispose of 15 gallons of waste.

Another option available is on-site medication destruction containers, typically comprised of activated carbon, clays, or other chemical mixtures that are added to the waste to render the waste unusable. While helpful to prevent abuse and diversion, these systems only add to the total weight of the medication to be disposed and are costly themselves.

There exists a need for more economical, convenient, and environmentally responsible means to dispose of unwanted liquid medications.

### SUMMARY

The disclosed apparatus serves as a medication deactivation apparatus, separating active pharmaceutical ingredients from the aqueous matrix of unwanted liquid medications, and sequestering them in a way that they are unusable and protected from leaching into the environment. During the deactivation process, the active pharmaceutical ingredients in unwanted liquid medications are adsorbed onto activated carbon, while inert ingredients (such as salts and water) are allowed to pass into a drainage system. At the end of its use life, the apparatus is disposed. This process spares users from the costs associated with the disposal of the inert ingredients (e.g. salts and water).

In using this apparatus, medications (generally in liquid form) are inserted through a portal on the top of the apparatus, and the liquid subsequently migrates through activated carbon in a gravity-feed process. As the medication migrates through the activated carbon, the active pharmaceutical ingredient of the medication is adsorbed onto the carbon and sequestered in an insoluble, inert form. This apparatus is an “open system”, and allows the treated liquid medication (e.g. the liquid minus the active pharmaceutical ingredient that was adsorbed onto the carbon) to be discharged into a drain following its passage through the carbon. After a defined use period, the remaining apparatus is disposed as a solid waste.

The “open system” of the disclosed apparatus contrasts with “closed systems” that capture all of the treated liquid medication and forces users to dispose of the liquid component of the medication into the solid waste stream. An advantage to the “open system” of the disclosed apparatus is that it is capable of treating a volume of liquid medications that greatly exceeds the volume of the apparatus that is ultimately disposed, thus minimizing amounts required to be disposed into solid waste.

For the disclosed apparatus to be effective, there are a number of requirements. First, there must be sufficient activated carbon present to adsorb the active pharmaceutical ingredients passed through the system. Second, the fluid pathway through the activated carbon must be sufficiently tortuous to ensure proper mixing and contact between the activated carbon and the dissolved active pharmaceutical ingredients of the liquid medication. Third, the contact time between the liquid medication and the activated carbon must be sufficiently lengthy to allow adsorption to take place. Finally, for practical use in a clinical setting, the disclosed apparatus must allow a rapid introduction of unwanted liquid medication so that users are not delayed in returning to other duties.

### BRIEF DESCRIPTION OF THE DRAWINGS

In the drawings like numerals depict like parts throughout:

FIG. 1 is a simplified schematic side view of a first embodiment of the disclosed portable apparatus and intermittently connected to a drainage system.

FIG. 2 is a simplified schematic side view of a second embodiment of the apparatus that is connectable to a drainage system.

FIG. 3 is a simplified schematic side view of third embodiment of the apparatus that includes an inner chamber for carbon and an outer chamber for collection of treated waste fluid.

FIG. 4 is a simplified schematic side view of yet another embodiment of the apparatus that includes an inner chamber for carbon and an outer chamber for collection of treated waste fluid that is connectable to a drainage system.

### DETAILED DESCRIPTION

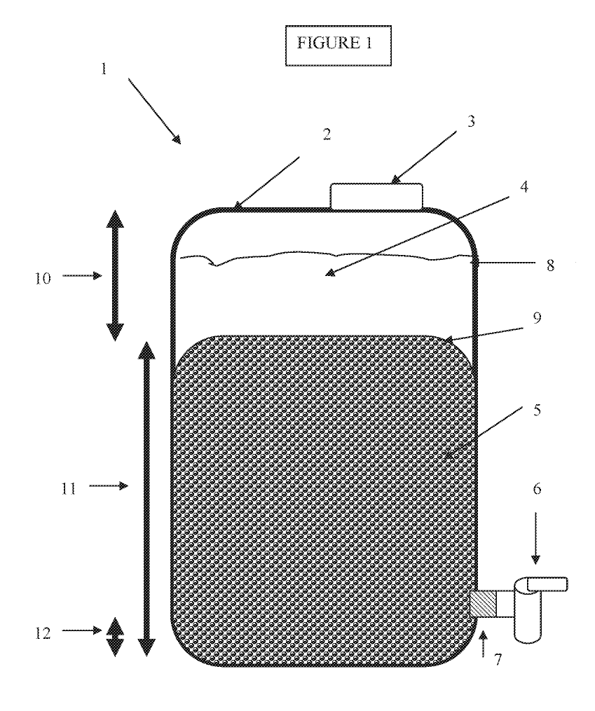

FIG. 1 is a side view schematic of a first embodiment of the disclosed apparatus. The embodiment includes a container 1. Container 1 has a recommended capacity for treating a volume of waste medication in liquid form which exceeds the volume of the container itself. That is, the internal volume of container 1 is less than the maximum recommended liquid waste volume that it is capable of treating. The outer wall 2 of container 1 are water impermeable, and made with materials that can be easily incinerated, such as polypropylene or polyethylene. Preferably, the outer wall 2 is comprised of a material that is translucent, and allows viewing of a liquid level 8 within the container.

The container cap 3 serves as a passageway or opening for insertion of waste medications in liquid and solid form. This cap may have an open vent (not depicted) that can serve as a convenient syringe port for liquids. The vent has an open diameter of at least 1/32 inch, and most preferably an open diameter of at least ⅛ inch. The vent need not be on the cap, and can alternatively be located elsewhere on the container 1 top. Importantly, the vent serves a dual purpose, besides being a syringe port it also serves to allow sufficient air to enter the container while it is being drained of liquid through spigot 6 without causing a “vacuum effect”. Without the air vent, air would be forced to enter through the spigot “in reverse” to relieve any preferential differential between the inner container and outer atmosphere that would be created as fluid is drained. This reverse air flow is restricted by carbon within the container of this design, and would result in significantly compromised liquid draining efficiency.

Container 1 is filled with granular activated carbon 5 to a fill line 9. The volume within the container above the fill line 9 occupies a space 4 of at least 250 ml, and more preferentially at least 500 ml. When space 4 is filled with liquid waste and container 1 is being drained, the liquid volume of space 4 will drain in 5 minutes or less, and most preferentially in 2 minutes or less. Container 1 is designed such that the presence of liquid in space 4 creates a gravitational pressure that facilitates this draining speed.

The granular activated carbon 5 loaded within container 1 is porous and has the capacity to accept waste liquid of at least 500 ml within the carbons occupied volume. When added to a fresh container 1, this at least 500 ml volume of liquid waste will not create a liquid level above the carbon fill line 9, e.g. it is a liquid volume in intimate, close contact with granular activated carbon within the container. When container 1 is filled with waste liquid just to the carbon line 9 and the container is drained, this volume of liquid waste will gravity drain in 5 minutes or more, and most preferentially in 10 minutes or more. Consequently, the container shape, granular carbon size, carbon porosity, and carbon volume combine to ensure sufficient time contact with the waste liquid to allow efficient adsorption of the active pharmaceutical ingredients to the activated carbon.

The container of FIG. 1 has a user operable spigot 6 that can be opened to allow draining of treated liquid medication. With the user operable spigot, the container is portable, in that it can be kept and used in a location separate from a drainage system such as a sink, and moved to a sink for ultimate draining at a time that is convenient for a user. Importantly, the spigot is separated from the granular activated carbon by a filter screen 7. Filter screen 7 serves to ensure that carbon (or other solid substances) will be restricted from passage through the spigot 6. Filter screen 7 can also serve to restrict liquid flow to help maintain the optimized contact and drain timing described in the preceding paragraph. Preferably the filter screen 7 has a mesh size between 8 and 32.

The waste fill line 8 will increase as container 1 is filled, and decrease as it is emptied. Preferably, as described above, the waste fill line 8 is viewable through the container material 2 when the fill line 8 is above the level of the activated carbon line 9.

Length 10 represents the height above the granular activated carbon within container 1. This length 10 is between 10 and 90% of the total container height or the internal volume of the container, and most preferably between 20 and 50% of the total container height or the internal volume of the container. Length 11 represents the height of the granular activated carbon within container 1. The weight of the activated carbon filling this height is at least 10 grams per liter of liquid waste volume that is to be treated, and most preferably at least 50 grams per liter of waste volume that is to be treated. Length 12 represents a height of activated carbon above the container bottom but below the spigot. The volume of granular activated carbon occupying length 12 has a capacity for free liquid of at least 10 ml, and most preferably at least 20 ml. This free liquid volume below the spigot serves to collect undissolved particulates, in a manner and location where those undissolved particulates will not interfere with the efficient draining through spigot 6 of container 1.

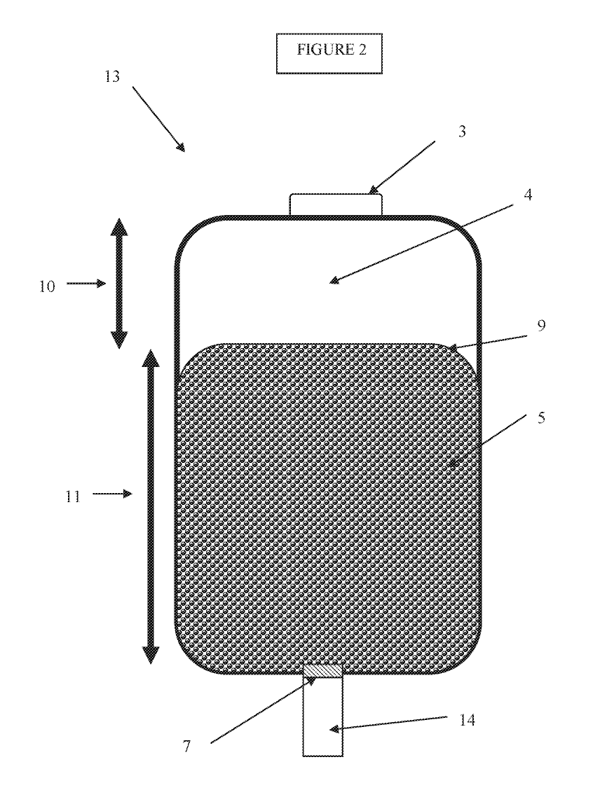

FIG. 2 represents another embodiment of the disclosed apparatus, depicted as a non-portable form of the container 13. Unlike container 1, the apparatus of container 13 can be connected to a drainage line by connector 14, and lacks the user operable spigot 6. The other components of FIG. 2 provide functionality identical to those described for container 1.

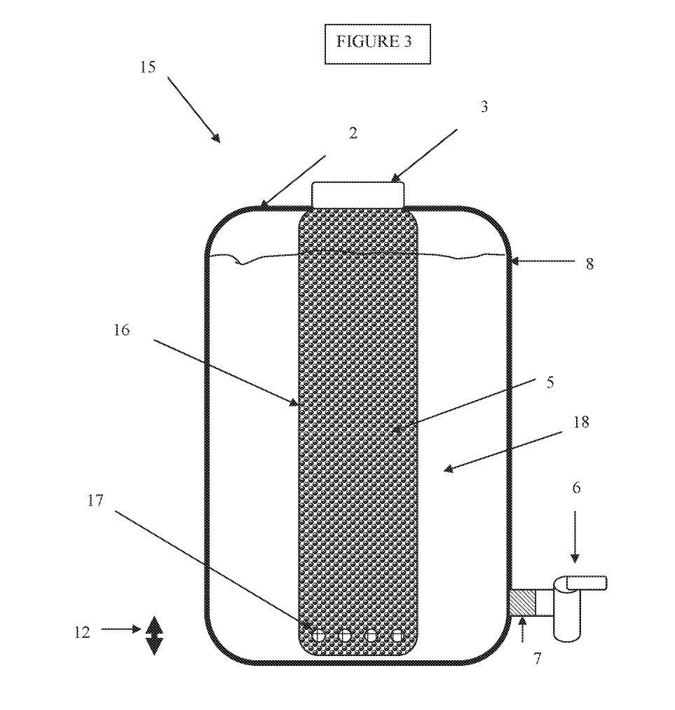

FIG. 3 represents another embodiment of the disclosed apparatus wherein the carbon fill line is brought close to the container cap, depicted as container 15. In this design, there is an inner chamber 16 for carbon that has outlets or openings 17 that are located near the bottom of the container and connected to an outer chamber 18. Outer chamber 18 serves to collect treated liquid waste before it is released to drainage. Importantly, the outlets 17 are optionally separated from the outer chamber 18 by a screen filter (not depicted) serving functionally as described previously for screen filter 7. Importantly, the outlets and screen filter combine to restrict the rate that waste fluid can be gravity fed though the carbon, insuring that waste fluid contact with carbon totals 5 minutes or more before it is released to the waste chamber.

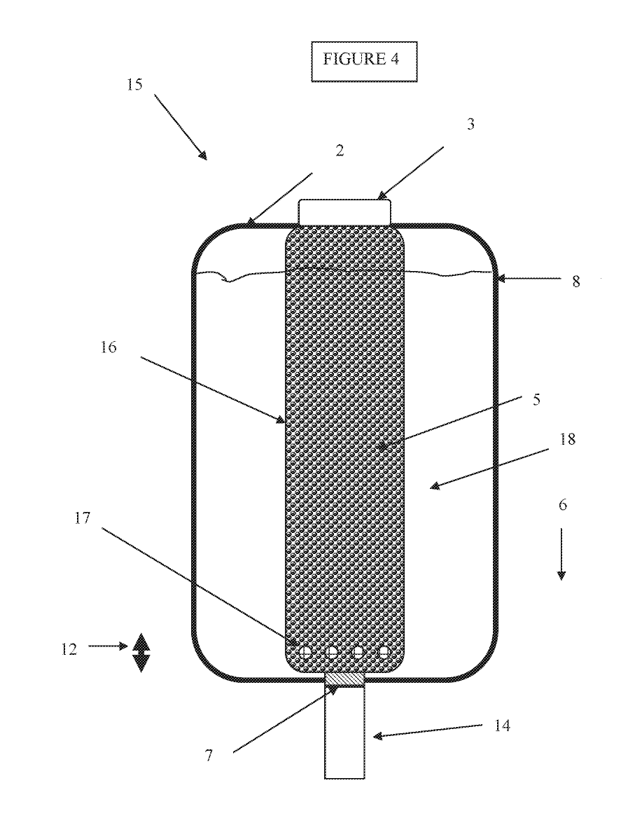

While the alternate design of FIG. 3 is shown with a user operable spigot 6 (shown with optional filter 7), those skilled in the art will realize an alternate design can have the drainage portal connected directly to a drain as shown in FIG. 4.

In some embodiments, the inner chamber is centrally located within the container. In some embodiments, the inner chamber is removable and in still some embodiments, the inner chamber is centrally located and removable.

### EXAMPLE

A 2.5 gallon plastic canister (Cary Company, SKU 57WSAN) was fitted with a ¾″ tap faucet (Cary Company SKU 57WWBT) having a screen mesh filter attached. The tap faucet was positioned with approximately 1″ of separation to the canister bottom. The canister was then filled with 7.5 lbs of granular activated carbon (GAC 1230C, Cabot Corp.). The height of the carbon fill line was 19 cm, and the height of the container space above the carbon fill line was 8 cm. A cap was placed on the canister, in which a ¼″ air vent/syringe port was drilled. Aqueous fluid was added into the canister to a level equal to the top of the carbon, using an amount of liquid of approximately 4 liters. The canister was then filled with water to its top, using an additional amount of liquid of approximately 3 liters. In total, the 7 liters of fluid added represented about 75% if the canisters total internal volume, the balance being the volume occupied by the added carbon.

The time to drain the 3 liter amount of aqueous fluid above the carbon line was approximately 1 minute, and the time to drain the 4 liter amount of aqueous fluid below the carbon line was over 6 minutes. Thus, this example illustrates that users desiring to treat an up to 3 liter amount of waste liquid medication with this device can do so quickly and conveniently, while the treatment apparatus' design ensures an significant contact period between carbon and the waste fluid before it can be fully discharged into a drain.

Disclosed are non-limiting embodiments of the present disclosure:

1. A portable apparatus for the disposal of waste liquid medications, comprising:

A container of known internal volume

An opening on said container for insertion of unwanted liquid medication

An amount of activated carbon contained within said container sufficient for reaction with a known volume of unwanted liquid medication

A user operable drain mechanism that can be periodically opened to release treated liquid medication.

2. The apparatus of embodiment 1 where the known volume of unwanted liquid medication that can be reacted with the activated carbon exceeds the volume of the container.
3. The apparatus of embodiment 1 where the release of treated medication includes a first amount of at least 250 ml that can be released in 5 minutes or less, and a last similar amount of at least 250 ml that is released in 5 minutes or more.
4. The apparatus of embodiment 1 where the release of treated medication includes a first amount of at least 1000 ml that can be released in 2 minutes or less, and a last similar amount of at least 1000 ml that is released in 5 minutes or more.
5. The apparatus of embodiment 1 where the user operated drain mechanism includes a filter
6. The apparatus of embodiment 1 where the height of the activated carbon within the container is between 50% and 80% of the total container height
7. The apparatus of embodiment 5 where the filter is a screen filter of between 8 and 32 mesh.
8. A stationary apparatus for the disposal of waste liquid medications, comprising:

A container of known internal volume

An opening on said container for insertion of unwanted liquid medication

An amount of activated carbon contained within said container sufficient for reaction with a known volume of unwanted liquid medication

A headspace volume within said container above said activated carbon of at least 250 ml

A drain mechanism to release treated liquid medication, such that a first 250 ml amount of treated liquid medication is released in 2 minutes or less; and a final 250 ml amount of treated medication is released in 5 minutes or more

What is claimed is:

1. An apparatus for disposal of liquid medications comprising
a container of a given internal volume;
an amount of activated carbon housed within the internal volume of the container and to capture active pharmaceutical ingredients in a liquid medication to be treated;
an opening for introduction of the liquid medication into the activated carbon;
an outlet for disposing a treated liquid medication after passage through the activated carbon.

2. The container of claim 1, wherein the container is disposable.

3. The container of claim 1, wherein the container comprises polypropylene or polyethylene.

4. The container of claim 1 further comprises a vent for passage of air.

5. The container of claim 1, wherein the outlet is below the inlet.

6. The apparatus of claim 1, wherein the outlet is a spigot.

7. The apparatus of claim 6, wherein the spigot is above a bottom of the container.

8. The apparatus of claim 6, wherein the apparatus is portable.

9. The apparatus of claim 1, wherein the outlet is connected to a drainage or other conduit.

10. The apparatus of claim 1, wherein the apparatus further comprises a filter located between the outlet and the interior volume of the activated carbon.

11. The apparatus of claim 10, wherein the filter screen has a size between 8 and 32 mesh.

12. The apparatus of claim 1, wherein activated carbon in the container is about 10 to about 90% of the internal volume of the container.

13. The apparatus of claim 1, wherein the activated carbon is a granular activated carbon.

14. An apparatus for disposal of liquid medications comprising:
a container of a given internal volume and an inner chamber within the internal volume;
an amount of activated carbon to absorb the liquid medication to be treated housed in the inner chamber;
the inner chamber having inner chamber openings towards the bottom of the inner chamber that allow egress of treated liquid medication passing through the activated carbon and into the internal volume of the container; the inner chamber allowing separation of the treated liquid medications from the activated carbon;
an opening for introduction of the liquid medication into the activated carbon; and
an outlet for disposing the treated liquid medication after passage through the activated carbon.

15. The apparatus of claim 14, wherein the inner chamber is removable.

16. The apparatus of claim 14, wherein the outlet is below the inlet.

17. A method of disposing liquid medications comprising:
providing an apparatus, the apparatus comprising:
a container of a given internal volume;
an amount of activated carbon housed within the internal volume of the container and to capture active pharmaceutical ingredients in a liquid medication to be treated;
an opening for introduction of the liquid medication into the activated carbon;
an outlet for disposing a treated liquid medication after passage through the activated carbon;
introducing the liquid medication into the opening of the container and allowing the liquid to pass through the activated carbon; and
disposing via the outlet of the container the liquid medication after passage through the activated carbon.

18. The method of claim 17, wherein the apparatus is portable.

19. The method of claim 17, wherein the outlet is connected to a drainage system or other conduit.

20. The method of claim 17, wherein the outlet is a spigot.
